(19) United States
(12) Patent Application Publication
(10) Pub. No.: US 2004/0034624 A1
(43) Pub. Date: Feb. 19, 2004

(54) Method and system of managing repository for a mobile workforce

(76) Inventors: Kenneth Deh-Lee, Union City, CA (US); Linda Tarby, Sunnyvale, CA (US); Eric Solari, Santa Clara, CA (US); Lynne Woodruff, Vancouver, WA (US)

Correspondence Address: HEWLETT-PACKARD COMPANY, Intellectual Property Administration, P.O. Box 272400, Fort Collins, CO, 80527-2400, US

(21) Appl. No.: 10/218,852

(22) Filed: Aug. 14, 2002

(51) Int. Cl. G06F 7/00

(52) U.S. Cl. 707/3

(57) ABSTRACT

A system and method for managing repository of data for mobile workforce, comprising receiving a subscription request for channels of content from a mobile user, determining if the user's mobile device is connected to the network, and sending dynamic content published on subscribed channels to by dynamically integrated with static content in one or more CDs.

### FIELD OF THE INVENTION

The present invention relates generally to delivering information to a global mobile workforce and, in particular, to a method and system for managing a repository of information for a group of global mobile users or a workforce and for delivering information customized for each individual mobile user.

### BACKGROUND OF THE INVENTION

Generally, customer support personnel are required to meet contractual agreements in providing maintenance or support services to a company's client, to reduce costs by completing tasks quicker, and to increase customer satisfaction by exceeding the customer's expectation. At the same time, customer support personnel are expected to support an ever-growing list of products offered by the company.

There is an ever-expanding number of information sources that customer support personnel must access and be familiar with, such as product manuals, World Wide Web or Internet sites, computer based training, Compact Disc (CD) subscriptions and the like. However, the required service information, such as parts information, self-test information, configuration data or failure codes are not necessarily integrated or organized for ready accessibility by customer support personnel. Each information source generally utilizes a different technology and a different interface, and typically stores content in varying formats.

Also, the service information must be current to be useful to customer support personnel in the field. The location of this service information may change without notification. For example, different web pages on a company's or a vendor's web site, such as information relating to the old version of the product, may not be available, and other information may be available only in hard copy or on CD. Also, even if customer support personnel knew the locations of the desired service information, they may not necessarily know which location has the most recent and accurate information. The proliferation of web sites only makes this situation worse for customer support personnel.

### BRIEF SUMMARY OF THE INVENTION

A method of managing a repository of data for a mobile workforce, comprising reciving a subscription request for one or more channels of content by a mobile user, determining if the user's mobile device is connected to the network; and sending dynamic content published on the subscribed channels to be dynamically integrated with static content in one or more CDs.

### BRIEF DESCRIPTION OF THE DRAWINGS

For a more complete understanding of the present invention, reference is now made to the following descriptions taken in conjunction with the accompanying drawings, in which:

FIG. 1 is a block diagram of a mobile web system architecture in accordance with an embodiment of the present invention;

FIG. 2 is a screen shot of informational view in accordance with an embodiment of the present invention;

FIG. 3 is a screen shot of reference view in accordance with an embodiment of the present invention;

FIG. 4 is a flow chart describing the user subscription process in accordance with an embodiment of the present invention;

FIGS. 5A and 5B are flow charts describing the backend extraction/publishing process for dynamic and static content in accordance with embodiments of the present invention; and

FIG. 6 is a flow chart describing the content integration process in accordance with an embodiment of the present invention.

### DETAILED DESCRIPTION

The present invention is readily implemented using presently available communication apparatuses and electronic components. The invention finds ready application in virtually all communications systems, including, but not limited to, the Internet, Local Area Network (LAN), Wide Area Network (WAN), intranets, private or public communication networks, wireless networks, satellite networks, cable networks, other online global broadcast networks and the like.

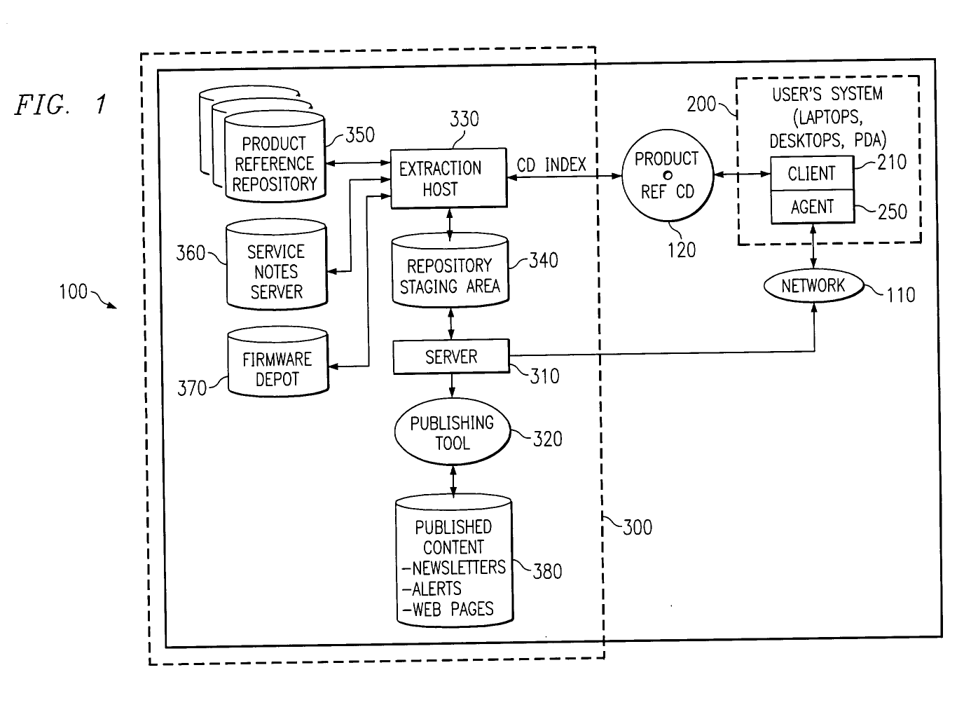

In accordance with an embodiment of the present invention, FIG. 1 illustrates mobile web system 100 in a customer support environment. Mobile web system 100 automates knowledge delivery to a mobile workforce. Also, it provides quick access to the latest available information, thereby enabling service repair professionals or customer support personnel to concentrate on the problem at hand instead of gathering and navigation through a plethora of information. System 100 provides customer support personnel in the field with quick access to the information and tools they need to deliver better hardware or software support to their company's clients.

In accordance with an embodiment of the present invention, mobile web system 100 operates on mobile device 200, which may be a laptop computer, a personal digital assistant (PDA), etc. Mobile device 200 connects to network 110 (such as the intranet, LAN, WAN, Internet, etc.) to receive the latest updates and information, and stores data locally for disconnected use, such as while traveling or on a customer's premises.

Generally, customer support personnel spend a great deal of time traveling to support clients' infrastructure, hardware and software equipment, maintaining customer relationship, etc., and less time in the office. As a result, access to a high speed LAN connection to obtain the requisite and latest service information from the company's server is greatly reduced. Tools that rely on tethered access to the company's servers or network can be problematic. Also, current wireless access technology is either unavailable in many places or too slow to be useful in accessing large files, such as an on-line parts manual.

Further, traditional communication media, such as emails, are not effective. With proliferation of electronic junk mail (spams), promotional emails, etc., it can be overwhelming and time consuming for a customer support personnel to navigate through piles of emails to find useful emails. Additionally, email may not be the most effective communication medium for time critical messages.

In accordance with an embodiment of the present invention, mobile web system 100 utilizes push technology to maintain one or more local repositories, such as a product reference repository, with the latest subscribed information. The local repositories (not shown) reside on mobile device 200. After installing mobile web application 210, the user subscribes to various information or reference materials, such as a parts list, error code description, configuration and diagnostic guides, service notes and, firmware reports, and the system populates the user's local repositories with the latest subscribed information. This provides customer support personnel who are at a customer's site, with easy access to the reference materials without being connected to company's network 110, servers or computer system. This can be particularly important on reactive service calls when customer support personnel need to conduct some investigation while away from the office, i.e., when company's network 110 are inaccessible to the customer support personnel.

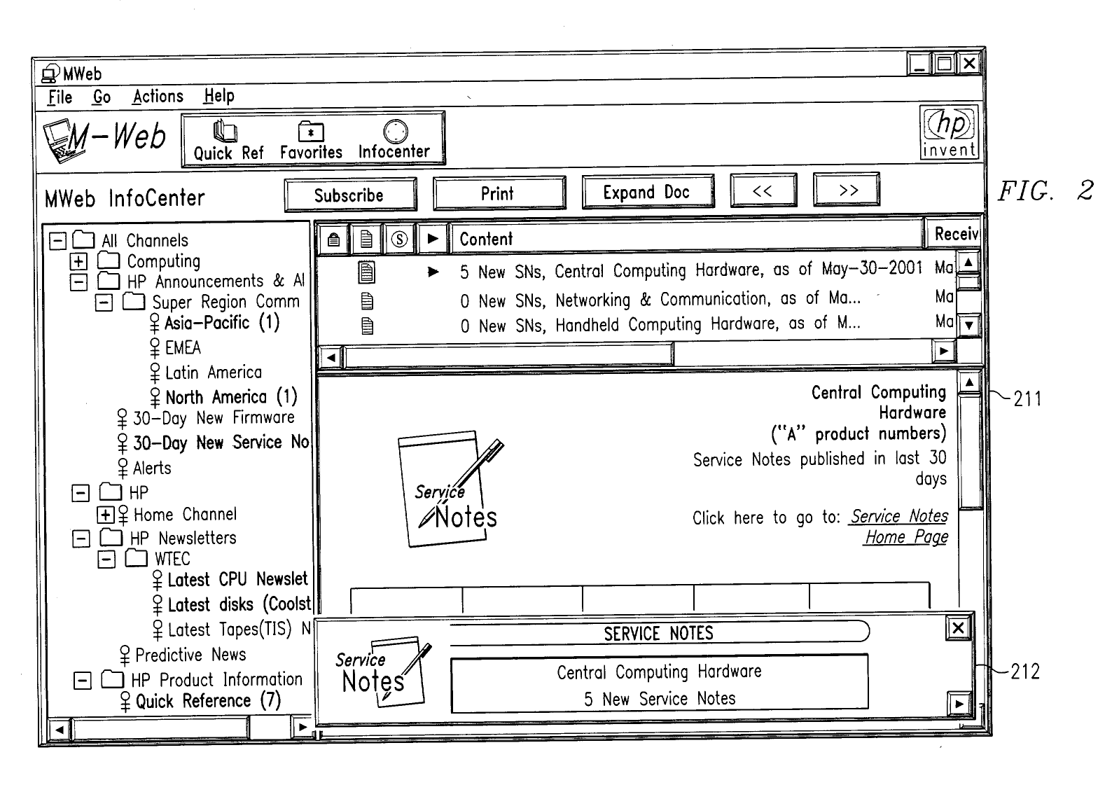

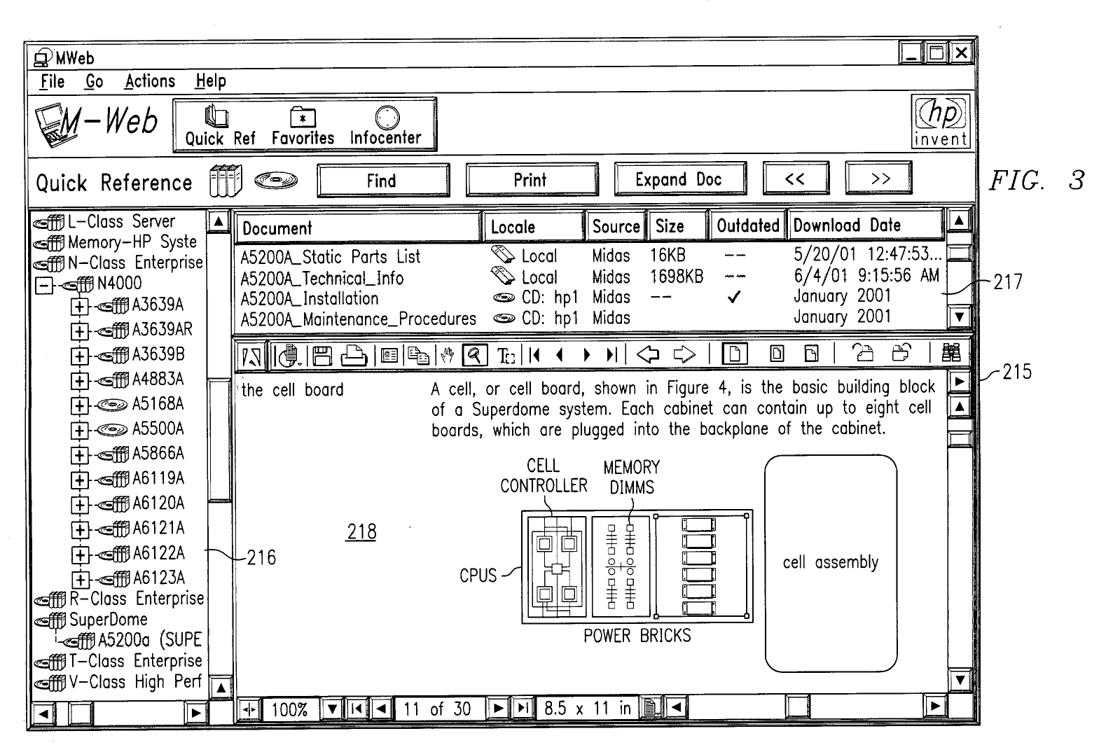

In accordance with an embodiment of the present invention, mobile web system 100 comprises a self-contained executable web-based client application hereinafter referred to as mobile client application or client 210 (FIG. 1). Mobile client application 210 comprises a user interface providing various views such as, informational view 211 (FIG. 2) and reference view 215 (FIG. 3) and an embedded web browser 218. The embedded web browser provides multi-document-type display features as shown in FIGS. 2 and 3. Preferably, the embedded web browser utilizes plug-ins to support various document formats, such as Excel, Word, PowerPoint, pdf files, etc. By using an embedded browser, mobile client application 210 obtains the benefits of executable applications, such as the ability to store application-specific state, programming flexibility, and multi-document handling features. FIG. 2 is an exemplary screen shot of informational view 211 of mobile client application 210, which provides users access to newsletters, alerts, service note notifications 212, etc.

Turning now to FIG. 3, there is illustrated an exemplary screen shot of reference view 215 of mobile client application 210. Pane 216 represents a hierarchical product tree, pane 217 is the document list for the highlighted product in pane 216. Pane 218 is a web browser object displaying the highlighted product reference document in pane 217.

Due to the typical storage capacity limitations of mobile device 200, mobile client application 210 employs a technique to selectively store information locally in the mobile device 200. That is, mobile client application 210 provides users or customer support personnel with quick and immediate access to the information or knowledge they use most frequently without requiring a network connection to their company's network or servers. In accordance with an embodiment of the present invention, mobile client application 210 updates information stored locally and distributes targeted bits of information to the users or customer support personnel, such as regional and/or organization-related news, alerts, etc. Mobile web system 100 additionally includes backend staging process or backend infrastructure system or portion 300 (FIG. 1) for collecting information and integrating the collected information into a single, standard product hierarchy or tree.

The customer benefits from mobile client application 210 of the present invention because it reduces the call closure time (by providing quicker and easier access to important and often-used repair information) and increases the customers support personnel efficiency. The mobile client application 210 keeps the customer support personnel informed with up-to-date technical support information from the company, such as company's support organizations and product divisions.

In accordance with an embodiment of the present invention, system 100 delivers tailored information to user's client or mobile device 200 from mobile server or server 310, such as based on a subscription process. That is, system 100 proactively delivers information to subscribers. In a system having nomadic (i.e., sporadically connected) subscribers, users, customer support or service personnel, the distribution control would place too much of a burden on mobile web system 100 if it was placed in server 310. Hence, in accordance with an embodiment of the present invention, system 100 divides the distribution control between the client and the server. Agent 250 residing in mobile device 200 polls server 310 for new information either periodically or when mobile device 200 connects to network 110.

Mobile client application 210, in accordance with an embodiment of the invention, uses a reliable multicast infrastructure or system to instantaneously deliver updated information to the subscriber or customer support personnel. Alternatively, mobile device 200 includes a wireless modem (not shown) to provide the user with a greater access or connectivity to network 110 for receiving information updates more frequently.

In accordance with an embodiment of the present invention, a user or subscriber subscribes to a particular information source to receive that subscribed information. The category that can be selected for subscription is called a channel. Once the subscriber subscribes to a particular channel, mobile client application 210 delivers the pertinent information packages of that channel to the subscriber. As shown in FIG. 1, agent 250 is installed on user's mobile device 200, such as laptop, PDA, etc. Agent 250 is usually started up as a background process that polls mobile server 310 in periodic intervals to request new information. After a request is received from agent 250, mobile server 310 determines the user's validity, the set of information that must be delivered, and any new subscription channels that need to be made available to the subscriber or user.

In accordance with an embodiment of the present invention, mobile server 310 delivers the information in a compressed package (such as a zip file) and can be encrypted. The present system can use either HyperText Transport Protocol (HTTP) or proprietary communication protocols to transmit the information to the user.

System 100 comprises a custom client application, such as mobile client application 210, and agent 250 residing in mobile device 200 and backend infrastructure system 300. In accordance with an embodiment of the present invention, mobile client application 210 comprises value added features such as the ability to search, file placement and customer presentation for the user. Backend infrastructure system 300 delivers various formats/types of files such as setup package, an executable or database files. Preferably, backend infrastructure system 300 includes automatic delivery of software and knowledge repository updates.

Once a user has subscribed to an information source (i.e., channel), new content can be delivered whenever the user is connected to network 100. It is appreciated that the present system can include a system channel for automatically updating configuration and system files. Also, the system operator can use the channels to communicate with its mobile workforce or solicit feedback from the users. For time sensitive information, such as alerts, service notes reports, backend infrastructure system 300 generates notifications or flashes which displays on user's mobile device 200 as a dialog box.

Mobile client application 210 notifies the user upon arrival of new information. In accordance with an embodiment of the present invention, agent 250 displays a pop-up dialog (generally referred to as a flash), such as service note notification 212 (FIG. 2). It is appreciated that a ticker window can be used instead of a flash. Since, agent 250 runs in the background of mobile device 200 collecting information, it can readily display messages when they arrive without waiting for the user interface of mobile client application 210 to be started, e.g., as shown in informational view 212 of FIG. 2.

As illustrated in FIG. 1, in accordance with an embodiment of the present invention, backend infrastructure system 300 of the present invention comprises mobile server 310 that enable publishers (i.e., company, vendor, third party, customer, customer support personnel, etc.) to submit as well as extract information from another source. Backend infrastructure system 300 additionally can include data gathering and statistics reporting modules, processes or routines which can be embedded into the infrastructure. This is useful in determining which categories of information are being downloaded more than others by the subscribers, thereby enabling the present system to utilize the statistics to make better decisions on content investments, i.e., which categories of content should be maintained and updated.

Aside from delivering data onto mobile system 200, mobile server 310 can perform remote processing via agent 250, such as launching scripts or executables. It is appreciated that the remote processing can include automated patching and upgrades, metrics collecting, etc., such that, for example, deployments of new or fixes are transparent to the users. Alternatively, agent 250 can display a flash on mobile device 200 to notify a user to begin the upgrade process.

In accordance with an embodiment of the present invention, the present system can utilize any known technology to deliver information from many disparate sources and offers subscriptions through a single user interface, such as from informational view 211 of FIG. 2. Preferably, the present system handles delivery and organization of technical product reference information differently from newsletters and other periodic publications. The product reference area is subdivided into multiple channels representing different product lines of company, such as laser jet printers, inkjet printers, personal computers, servers, etc. Within each channel, the user can select additional add-on content such as service notes. Mobile client application 210 integrates the information from various product reference channels into a single product tree after delivery, as shown in pane 216 of reference view 215 (FIG. 3).

Reference view 215 of mobile client application 210 offers user access to the technical reference documents. Mobile client agent 250 deposits more dynamic information such as alerts, newsletters and periodic reports into folders representing the viewable channels and accessible through informational view 211. As shown in FIG. 1, in accordance with an embodiment of the present invention, the publishing process for product reference information or automated extraction process (i.e., extraction host 330) is separate and different from the publishing process for dynamic information (i.e., publishing tool 320). Extraction host 330 and publishing tool 320 extract or publish information from the knowledge repositories or databases. The knowledge repositories comprises published content repository or database 380 accessible and managed by publishing tool 320, and product reference repository 350, service notes server 360 and firmware depot 370 accessible by extraction host 330. It is appreciated that the knowledge repositories are not only accessible and populated by company personnel, but can be accessible and populated with information published by a partner, supplier, vendor, etc. For example, the knowledge repositories can store supplier's catalog, thereby enabling the supplier to publish information to field workforce or company's customer support personnel.

In accordance with an embodiment of the present invention, mobile client application 210 organizes and presents various contents to be used by the user (i.e., mobile workforce or customer support personnel) in a easily navigable product tree as illustrated in informational view 211 of FIG. 2 and pane 216 of reference view 215 of FIG. 3. That is, various product information and other information such as newsletters are presented in a tree structure, i.e., under “All Channels” folder or branch (FIG. 2), there is “super region communications”, “HP Newsletters” and “HP Product Information” leaf folders, etc. The tree allows users to navigate quickly and intuitively through information, thereby enabling the user or customer support personnel to quickly find the desired information. Once at a leaf folder representing a specific product (product number), all information pertaining to that product is available regardless of its origin (i.e., “one-stop-shopping” approach). Mobile server 310 performs a backend extract and merge process via extraction host 330 to integrate new content or information into the product tree. Extraction host 330 and publishing tool 320 extract information from the knowledge repositories and webcast the extracted information to mobile client agent 250 via server 310. After the extraction host 330 completes and validates the backend process, mobile server 310 delivers the appropriate portions of the reference materials to the users via agent 250 associated with user's mobile device 200. That is, in accordance with an embodiment of the present invention, mobile server 310 delivers subscribed content (i.e., updates or new content available on user's subscribed channel) onto the user's mobile device 200 via agent 250.

In accordance with an embodiment of the present invention, mobile web system 100 utilizes one or more product reference compact discs (CDs) to reduce the amount of download overhead for the local product repository residing in the mobile device's memory, hard disc, etc. (not shown). For example, mobile web system 100 can store older, static product information in one or more CDs to provide a set of product reference CDs 120. Mobile client application 210 of the present invention seamlessly and dynamically integrate these two sources of content (i.e., local hard-drive and CD) for mobile device 200 to enable the user to access both sets of information through a single product or integrated hierarchical tree, as shown in panes 216 and 217 of reference view 215 (FIG. 3). As illustrated in pane 217 of reference view 215, document “A5200A_Technical_Info” resides in the local repository (not shown) and document “A5200A_Installation” resides in product reference CD 120 labeled “CD:hp1”. In accordance with an embodiment of the present invention, mobile client application 210 stores a hierarchical informational tree containing the product hierarchy information of the product reference CD 120 in the hard-drive (not shown) of mobile device 200. Accordingly, mobile client application 210 dynamically integrates the hierarchical informational tree of the local repository and CD hierarchical informational tree (or CD tree) to provide an integrated hierarchical or product tree, thereby permitting the user to seamlessly view and retrieve information regardless of their location. It is appreciated that the utilization of CDs reduces the requisite disk space as well as the network usage required to download the information from mobile server 310, thereby reducing the time associated with updating the information in the local repository of the mobile device 200. This naturally extends the present invention beyond laptops to mobile device 200 having limited storage capacity, such as a PDA.

In accordance with an embodiment of the present invention, mobile client application 210 dynamically integrates the hierarchical information tree of the local repository and the CD tree into the integrated hierarchical tree by eliminating duplicate content. It is appreciated that a branch connects the elements (i.e., nodes or leaves) of the informational or product tree.

In accordance with an embodiment of the present invention, extraction host 330 generates CD updates to product reference CD 120, thereby synchronizing the static content to the hierarchical informational tree which dynamically changes based on the dynamic content published on the subscribed channel and a version number of product reference CD 120 and transmits the CD updates to agent 250 over network 110.

In accordance with an aspect of the present invention, mobile client agent 250 processes pushed data with available CPU cycles and network bandwidth to further reduce the impact of downloading files and information from mobile server 310. Preferably, mobile web server 310 transmitting and applying only byte-differences within a changed file to further improve the performance of the present system.

Turning now to FIG. 1, there is illustrated the mobile web system architecture and the data flow within mobile web system 100 in accordance with an embodiment of the present invention. The process of preparing and delivering informational updates to a mobile or nomadic workforce in accordance with an embodiment of the present invention is described. Extraction host 330 performs automated extraction process to extract information from product reference repository 350, service notes server 360 and firmware depot 370. In accordance with an embodiment of the present invention, extraction host 330 extracts and merges information from several repositories on a periodic interval. Extraction host 330 runs data validation steps and determines the differences between the current and previous extracts. Extraction host 330 performs the validation steps to minimize the chance of delivering bad data or redundant information and to determine the download impact to the user or subscriber. Extraction host 330 also maintains the CD index or hierarchical informational tree to manage the integrated product tree and update any changes to the integrated product tree as result of the current extract.

Once extraction host 330 validates the data, the extracted data is moved to repository or staging area 340. Mobile server 310 integrates and merges the extracted data in repository 340 into a structure for delivery to the subscribers or users. That is, the extracted content is merged while in repository 340. Mobile server 310 uses the information provided in repository 340 to create deliverable packages for the user. For non-scheduled data, such as newsletters, alerts, etc., publication tool 320 publishes content to the users. It is appreciated that content providers, such as suppliers, vendors, etc., can use publishing tool 320 to publish content, e.g., scraper to scrape an existing web page. Publishing tool 320 stores the published content in published content repository or database 380.

In accordance with an embodiment of the present invention, agent 250 downloads the information extracted from various knowledge repositories 350, 360, 370, as well as published content from published content repository 380 to the client whenever agent 250 determines that new content is available on the subscribed channel.

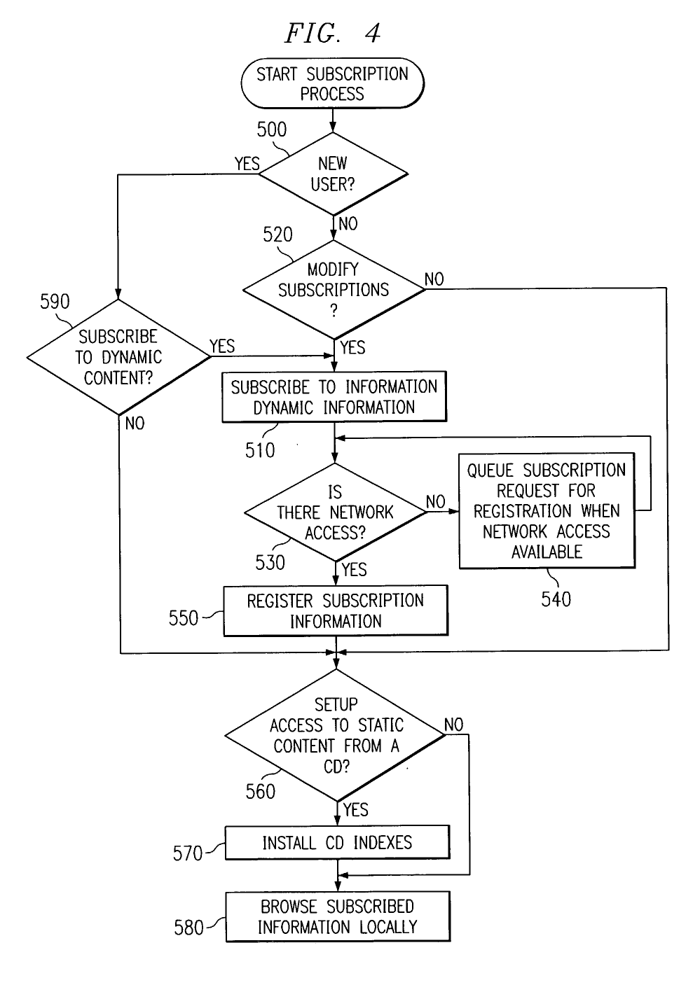

The user subscription process in accordance with embodiment of the present invention is described in conjunction with FIGS. 1 and 4. When the user or subscriber (i.e., customer support personnel) initiates mobile client application 210, mobile client application 210 determines if the user is new to mobile web system 100 (i.e., a new user) in step 500. If the user is a new user, mobile client application 210 displays the channels or information available from mobile web server 310 in step 510. The user can alternatively decide to skip subscribing to dynamic information (step 510) in step 590 and configure access to static content in step 560 as described in paragraph 44. In such cases, the client application 210 will be used to only browse static content on the product reference CD 120. If the user is an existing user, then the user can elect to modify his/her subscriptions in step 520, for example by clicking the subscribe button in informational view 211 of FIG. 2. If mobile client application 210 detects that the subscribe button has been selected or clicked by the user, then mobile client application 210 proceeds to step 510 and displays the channels or information that are available from mobile server 310.

After the user has completed the subscription request (i.e., selecting the desired channels/information), in step 530, agent 250 determines if mobile device 200 is connected to network 110. If agent 250 determines that mobile device 200 is connected to network 110, agent 250 transmits the subscription request to mobile server 310 for registration over network 110 in step 550. Mobile server 310 registers user's subscription request in step 550. Preferably, mobile server 310 stores the subscription requests of each user. However, if mobile device 200 is not connected to network 110, agent 250 queues the subscription request for future registration in step 540 and proceeds to step 530 to periodically determine if mobile device 200 is connected to network 110.

The user can setup access to the product reference CD 120 in step 570 by invoking a option from the mobile client application 210 to initiate installation of the CD Index onto the mobile device 200. Once it is completed, the static content on the product reference CD 120 can be accessed. The product reference CD 120 contains a snapshot of the entire technical repository at a given point in time. When new information for the subscription is available on the mobile server 310, the mobile server 310 transmits the subscribed dynamic content (i.e., documents are webcasted, broadcasted or multicasted to the mobile device 200) as they become available to agent 250 residing on the user's mobile device 200 over network 110 in step 580. The mobile server 310 determines the necessary subscribed content to deliver by comparing what has been sent and what is new. The agent 250 on the mobile device 200 periodically polls the mobile server 310 for new content. The information delivered for subscription can also supersede content on the product reference CD 120, allowing the user to always view the newest revision of a document.

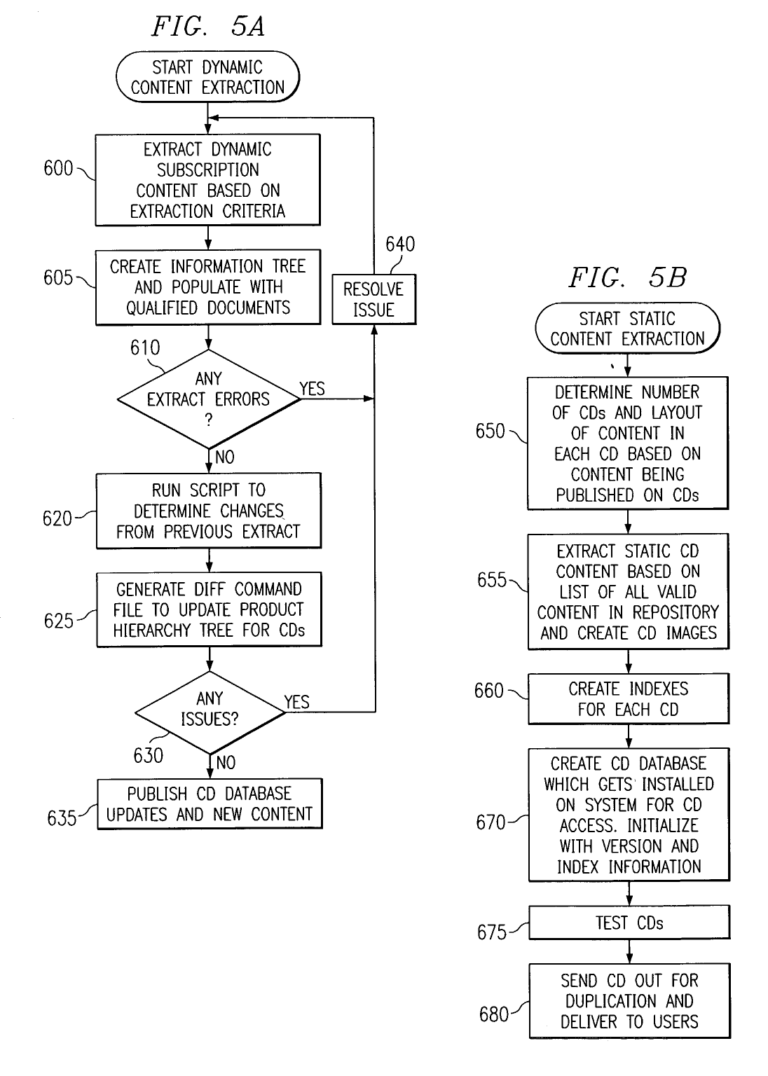

Turning now to FIG. 5, the backend extraction/publishing process for dynamic and static content in accordance with an embodiment of the present invention is described in conjunction therewith. Extraction host 330 extracts dynamic content for distribution to the global work force based on extraction criteria established by system operator (step 600). Extraction host 330 generates a new informational or product hierarchical tree or updates an existing tree based on the extracted dynamic content and populates the tree with appropriate extracted content in step 605.

After generating the product or informational hierarchical tree or index, extraction host 330 verifies or validates the accuracy of the product tree in step 610. If any errors are detected, extraction host 330 resolves the detected error in step 640 and returns to step 600 to re-extract the dynamic content based on the extraction criteria. However, if no errors are detected, extraction host 330 proceeds to step 620. Extraction host 330 runs a script to determine changes from the previous extract in step 620 and generates a difference command file to update the product hierarchy tree for product reference CDs 120 in step 625.

Before publishing the CD index updates, extraction host 330 verifies or validates the accuracy of the updates in step 630. If no errors are detected, extraction host 330 publishes the CD database updates and new dynamic content to the mobile workforce (customer support personnel) via agents 250 and mobile server 310 in step 635. However, if any errors are detected, extraction host 330 proceeds to step 640 to resolve the detected errors. After the errors are resolved, extraction host 330 returns to step 600 to re-extract the dynamic content based on the extraction criteria.

For static content, a system operator or publishing group determines the number of product reference CDs 120 and the layout of the content in each CD 120 required to store or house the content to be published to CDs in step 650. After determining the number of CDs, extraction host 330 extracts the content to be published (e.g., based on a list generated by the system operator) from various knowledge repositories and generates or forms CD images of the extracted content in step 655. Also, extraction host 330 generates a CD index for each CD in step 660.

Extraction host 330 generates a database of all available CDs with version and index information in step 670. Before distributing newly generated product reference CDs 120 to the mobile workforce, extraction host 330, the system operator or the publishing group verifies or validates the accuracy of product reference CDs 120 in step 675. If no errors are detected, system operator distributes the product reference CDs 120 to the mobile workforce to be used in conjunction with the dynamic content stored in the local repository of user's mobile device 200 in step 680.

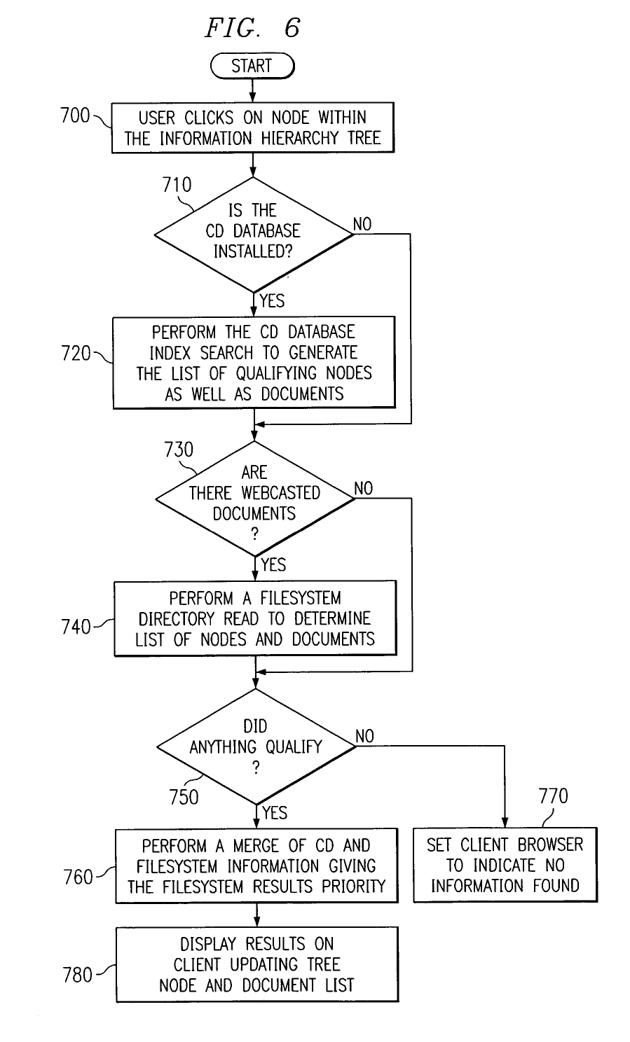

Turning now to FIG. 6, the content integration process in accordance with an embodiment of the present invention is described therewith. The user clicks on a node within the information or product hierarchical tree, such as from reference view 215 of mobile client application 210, to search for a particular content or information in step 700. Mobile client application 210 determines if product reference CD database is accessible (i.e., installed) on its associated mobile device 200 in step 710. If it is determined that product reference CD database is accessible from mobile device 200, mobile client application 210 searches the CD index or CD database index to generate a list of qualifying (or matching) nodes and corresponding documents in step 720. Mobile client application 210 then proceeds to step 730 to determine if mobile device 200 has any webcasted documents stored in its local repository.

However, if product reference CD is not accessible, mobile client application 210 proceeds directly to step 730. If mobile device 200 has webcasted documents, mobile client application 210 searches the local repository or file system directory to generate a list of qualifying (or matching) nodes and corresponding documents in step 740. Thereafter, mobile client application 210 proceeds to step 750 and makes an inquiry to determine if any qualifying nodes have been found. However, if there is no webcasted documents in the local repository, mobile client application 210 proceeds directly to step 750.

If the inquiry in step 750 is answered in the affirmative, mobile client application 210 merges the two lists of qualifying nodes into a single list by giving priority to the results from the local repository or file system directory in step 760. It is appreciated that mobile client application 210 may not necessary perform the merge operation of step 760 if there is only one list of qualifying nodes. Mobile client application 210 then displays the results (step 780), such as a list of qualifying nodes along with corresponding documents, on the screen of mobile device 200, such as a list shown in pane 217 in FIG. 3. However, if the inquiry in step 750 is answered in the negative, mobile client application 210 displays nothing or a message that the information is unavailable on the screen of mobile device 200 in step 770.

In accordance with an embodiment of the present invention, mobile client application 210 includes voice-based interfaces to enable the user to interact with mobile web system 100 in hands-free mode, i.e., voice commands. The voice-based interfaces are not only useful while driving but also assists the user in dealing with small keyboards. Accordingly, in accordance with an aspect of the present invention, mobile web system 100 utilizes VXML or voice XML, a voice extensible markup language, or the like to present an application's content as synthesized voice. That is, VXML enabled mobile server 310 can deliver the content as speech to mobile device 200 with VXML enabled mobile client application 210.

The use of voice-based interfaces removes the challenge of entering text on a small or non-existent keyboard of mobile device 200, such as to provide a description of the product. Accordingly, in accordance with an embodiment of the present invention, mobile client application 210 can digitize a voice clip describing the cause or fix, and store the voice clip as an audio file for subsequent processing by the backend infrastructure system 300. In addition to using voice for data entry, voice synthesis also can be used to render email or other messaging communication as speech. Whereas many mobile professionals are already quite accustomed to listening and responding to voice mail while driving, the same can be done with email. Therefore, the same mobile device that provides a user interface into workflow, parts availability, and technical reference information can also be used for mobile communication.

What is claimed is:

1. A method of managing a repository of data for a mobile workforce, comprising:
receiving a subscription request for one or more channels of content from a mobile user;
determining if a mobile device associated with said mobile user is connected to a network;
sending dynamic content published on subscribed channels to be dynamically integrated with static content in one or more CDs by said mobile device over said network.

2. The method of claim 1 further comprising:
queuing said subscription request if it is determined that said mobile device is not connected to said network.

3. The method of claim 1 further comprising:
extracting dynamic content from knowledge repositories connected to said network for each channel based on an extraction criteria.

4. The method of claim 1 further comprising:
periodically transmitting a request for dynamic content published on each subscribed channel to a mobile server over said network if it is determined that said mobile device is connected to said network;
receiving new dynamic content published on each subscribed channel from said mobile server in response to said request over said network by said mobile device; and
dynamically integrating said new dynamic content with said static content by said mobile device.

5. The method of claim 1 further comprising:
generating a hierarchical informational tree based on said dynamic content published on said each subscribed channel by said mobile device; and
dynamically integrating said hierarchical informational tree and a CD tree to provide an integrated hierarchical tree by said mobile device.

6. The method of claim 5 wherein the step of dynamically integrating further comprises:
eliminating branches to older version of content or duplicate content from said integrated hierarchical tree.

7. The method of claim 5 further comprising:
generating CD updates for said one or more CDs to synchronize said static content to said hierarchical informational tree which dynamically changes based on said dynamic content published on said each subscribed channel and a version number of said one or more CDs;
sending said CD updates to said mobile device over said network.

8. The method of claim 7 wherein the step of dynamically integrating further comprises:
dynamically integrating nodes of said integrated hierarchical tree that are being accessed by said mobile user.

9. The method of claim 5 further comprising:
accessing said integrated hierarchical tree to retrieve content from a content source, said content source being either a local repository or said one or more CDs.

10. The method of claim 9 wherein the step of accessing further comprises:
accessing a node of said integrated hierarchical tree;
querying said local repository and said one or more CDs to dynamically integrate said hierarchical informational tree and said CD tree to update said node of said integrated hierarchical tree; and
displaying said content.

11. The method of claim 9 wherein the step of accessing further comprises:
accessing said integrated hierarchical tree to retrieve said content via a voice command; and
delivering said content as speech to said mobile device.

12. The method of claim 4 wherein the step of receiving said dynamic content and said CD updates via either webcast or multicast.

13. A system for managing a repository of data for a mobile workforce, comprising:
a mobile server connected to a network;
a mobile device associated with a mobile user connectable to said network;
a mobile client application operating in said mobile device for subscribing to one or more channels of content to provide a subscription request; and
an agent operating on said mobile device for determining if said mobile device is connected to said network and transmitting said subscription request to said mobile server over said network if it is determined that said mobile device is connected to said network; and
wherein said mobile server is operable to transmit to said agent dynamic content published on each subscribed channel to be dynamically integrated with static content in one or more CDs by said mobile client application.

14. The system of claim 13 wherein said agent is operable to queue said subscription request if it is determined that said mobile device is not connected to said network.

15. The system of claim 13 wherein said agent is operable to periodically transmit a request for dynamic content published on each subscribed channel to said mobile server over said network if it is determined that said mobile device is connected to said network; wherein said mobile server is operable to transmit new dynamic content published on each subscribed channel to said agent in response to said request over said network; and wherein said mobile client application is operable to dynamically integrate said new dynamic content with said static content.

16. The system of claim 13 wherein said mobile server comprises:
an extraction host for extracting dynamic content from knowledge repositories connected to said network for each channel based on an extraction criteria.

17. The system of claim 13 wherein said mobile client application is operable to generate an informational hierarchical tree based on said dynamic content published on said each subscribed channel and to dynamically integrate said hierarchical informational tree and a CD tree of said one or more CDs to provide an integrated hierarchical tree.

18. The system of claim 17 wherein said mobile client application is operable to eliminate branches to older version of content or duplicate content from said integrated hierarchical tree.

19. The system of claim 17 wherein mobile server is operable to generate CD updates for said one or more CDs to synchronize said static content to said hierarchical informational tree which dynamically changes based on said dynamic content published on said each subscribed channel and a version number of said one or more CDs and to transmit said CD updates to said agent over said network.

20. The system of claim 19 wherein said mobile client application is operable to dynamically integrate nodes of said integrated hierarchical tree that are being accessed by said mobile user.

21. The system of claim 17 wherein said mobile device includes a local repository; and wherein mobile client application is operable to receive an input selection from said mobile user to access a node in said integrated hierarchical tree, and to retrieve content associated said input selection from a content source, said content source being either said local repository or said one or more CDs.

22. The system of claim 21 wherein said mobile client application is operable to query said local repository and said one or more CDs to dynamically integrate said hierarchical informational tree and said CD tree to update said node of said integrated hierarchical tree and to display said content associated with said accessed node on said mobile device.

23. The system of claim 17 wherein said mobile client is operable to receive a voice command as said input selection from said mobile user; and wherein said mobile client application is operable to access said integrated hierarchical tree to retrieve said content via said voice command and to present said content as speech to said mobile user.

24. The system of claim 13 wherein said mobile web server is operable to webcast or multicast said dynamic content and said CD updates via said network.

25. A system for managing repository of data for mobile workforce, comprising:
means for subscribing to one or more channels of content by a mobile user to provide a subscription request;
means for determining if a mobile device associated with said mobile user is connected to a network;
means for transmitting said subscription request to a mobile server from said mobile device over said network if it is determined that said mobile device is connected to said network;
means for receiving dynamic content published on each subscribed channel from said mobile server by said mobile device; and
means for dynamically integrating said dynamic content with static content in one or more CDs.

26. The system of claim 25 further comprising:
means for queuing said transaction request if it is determined that said mobile device is not connected to said network.

27. The system of claim 25 further comprising:
means for periodically transmitting a request for dynamic content published on each subscribed channel to said mobile server over said network if it is determined that said mobile device is connected to said network; and
means for receiving new dynamic content published on each subscribed channel from said mobile server in response to said request over said network by said mobile device.

28. The system of claim 25 further comprising:
means for extracting dynamic content from knowledge repositories connected to said network for each subscribed dynamic channel based on a channel extraction criteria.

29. The system of claim 25 further comprising:
means for generating a hierarchical informational tree based on said dynamic content published on said each subscribed channel; and
means for dynamically integrating said hierarchical informational tree and a CD tree to provide an integrated hierarchical tree.

30. The system of claim 29 further comprising:
means for generating CD updates to said one or more CDs to synchronize said static content to said hierarchical informational tree which dynamically changes based on said dynamic content published on said each subscribed channel and a version number of said one or more CDs;
means for transmitting said CD updates to said mobile device over said network.
